(19) United States
(12) Patent Application Publication
(10) Pub. No.: US 2026/0186253 A1
(43) Pub. Date: Jul. 2, 2026

(54) CAMERA OPTICAL LENS

(71) Applicant: AAC OPTICS (CHANGZHOU) CO., LTD., Changzhou City (CN)

(72) Inventor: Zhen Huang, Changzhou (CN)

(21) Appl. No.: 19/294,227

(22) Filed: Aug. 7, 2025

Related U.S. Application Data
(63) Continuation of application No. PCT/CN2024/143913, filed on Dec. 30, 2024.

(51) Int. Cl. G02B 13/00; G02B 9/60

(52) U.S. Cl. CPC G02B 13/0045; G02B 9/60

(57) ABSTRACT

The present disclosure relates to the field of optical lens, and provides a camera optical lens, including, from an object side to an image side in sequence, a first lens, a second lens, a third lens, a fourth lens, and a fifth lens. The camera optical lens satisfies: −0.65≤f3/f4≤−0.50, 0.25≤(d3+d5)/TTL≤0.35, and 1.00≤(R1+R2)/f1≤2.00, where f3 represents a focal length of the third lens, f4 represents a focal length of the fourth lens, d3 represents an on-axis thickness of the second lens, d5 represents an on-axis thickness of the third lens, TTL represents a total track length of the camera optical lens, R1 represents a curvature radius of an object side surface of the first lens, R2 represents a curvature radius of an image side surface of the first lens, and f1 represents a focal length of the first lens.

### CROSS REFERENCE TO RELATED APPLICATIONS

The present application is a continuation of PCT Patent Application No. PCT/CN2024/143913, entitled “CAMERA OPTICAL LENS,” filed on Dec. 30, 2024, which is incorporated herein by reference in its entirety.

### TECHNICAL FIELD

The present disclosure relates to the field of optical lens, and in particular to a camera optical lens applicable to handheld terminal devices such as smart phones and digital cameras, and to camera devices such as monitors and PC lenses.

### BACKGROUND

With the emergence of smart devices in recent years, the demand for miniature camera optical lenses is increasing day by day, but the pixel size of the photosensitive devices is shrinking, coupled with the current development trend of electronic products being that their functions should be better and their shape should be thin and small, miniature camera optical lens with good imaging quality therefor has become a mainstream in the market. In order to obtain better imaging quality, the lenses traditionally adopt a multi-piece lens structure. And, with the development of technology and the increase of the diverse demands of users, and under the circumstances that the pixel area of photosensitive devices is shrinking steadily and the requirement of the system for the imaging quality is improving constantly, the five-piece lens structure gradually appear in lens design. There is an urgent need for wide-angle camera lenses which have good optical characteristics and small volume, and the chromatic aberration of which is fully corrected.

### SUMMARY

Aiming at the above problem, the main purpose of the present disclosure is to provide a camera optical lens that has good optical performance and meets the design requirements of large aperture, ultra-thin, and wide-angle.

To this end, the technical solutions of the present disclosure provide a camera optical lens, including, from an object side to an image side in sequence, a first lens with a negative refractive power, a second lens with a positive refractive power, a third lens with a positive refractive power, a fourth lens with a negative refractive power, and a fifth lens with a positive refractive power. The camera optical lens satisfies the following conditions: −0.65≤f3/f4≤−0.50, 0.25≤(d3+d5)/TTL≤0.35, and 1.00≤(R1+R2)/f1≤2.00, where f3 represents a focal length of the third lens, f4 represents a focal length of the fourth lens, d3 represents an on-axis thickness of the second lens, d5 represents an on-axis thickness of the third lens, TTL represents a total track length of the camera optical lens, R1 represents a curvature radius of an object side surface of the first lens, R2 represents a curvature radius of an image side surface of the first lens, and f1 represents a focal length of the first lens.

As an improvement, the camera optical lens further satisfies the following condition: −4.00≤R9/R10≤−1.50, where R9 represents a curvature radius of an object side surface of the fifth lens, and R10 represents a curvature radius of an image side surface of the fifth lens.

As an improvement, the camera optical lens further satisfies the following condition: 1.81≤ET1/d1≤2.10, where ET1 represents an edge thickness of the first lens, and d1 represents an on-axis thickness of the first lens.

As an improvement, the camera optical lens further satisfies the following condition: 2.00≤f5/d9≤3.00, where f5 represents a focal length of the fifth lens, and d9 represents an on-axis thickness of the fifth lens.

As an improvement, the object side surface of the first lens is concave in a paraxial region, and the image side surface of the first lens is concave in the paraxial region. The camera optical lens further satisfies the following conditions: −1.49≤f1/f≤−1.40, 0.40≤(R1+R2)/(R1−R2)≤0.57, and 0.101≤d1/TTL≤0.118, where f represents a focal length of the camera optical lens, and d1 represents an on-axis thickness of the first lens.

As an improvement, an object side surface of the second lens is convex in a paraxial region, and an image side surface of the second lens is concave in the paraxial region. The camera optical lens further satisfies the following conditions: 4.43≤f2/f≤5.49, −2.76≤(R3+R4)/(R3−R4)≤−1.39, and 0.177≤d3/TTL≤0.249, where f2 represents a focal length of the second lens, f represents a focal length of the camera optical lens, R3 represents a curvature radius of the object side surface of the second lens, R4 represents a curvature radius of the image side surface of the second lens, and d3 represents an on-axis thickness of the second lens.

As an improvement, an object side surface of the third lens is convex in a paraxial region, and an image side surface of the third lens is convex in the paraxial region. The camera optical lens further satisfies the following conditions: 1.60≤f3/f≤1.71, 0.24≤(R5+R6)/(R5−R6)≤0.38, and 0.049≤d5/TTL≤0.109, where f represents a focal length of the camera optical lens, R5 represents a curvature radius of the object side surface of the third lens, R6 represents a curvature radius of an image side surface of the third lens, and d5 represents an on-axis thickness of the third lens.

As an improvement, the object side surface of the fourth lens is convex in a paraxial region, and the image side surface of the fourth lens is concave in the paraxial region. The camera optical lens further satisfies the following conditions: −3.27≤f4/f≤−2.57, 2.42≤(R7+R8)/(R7−R8)≤3.00, and 0.040≤d7/TTL≤0.045, where f represents a focal length of the camera optical lens, R7 represents a curvature radius of the object side surface of the fourth lens, R8 represents a curvature radius of an image side surface of the fourth lens, and d7 represents an on-axis thickness of the fourth lens.

As an improvement, an object side surface of the fifth lens is convex in a paraxial region, and an image side surface of the fifth lens is convex in the paraxial region. The camera optical lens further satisfies the following conditions: 1.92≤ f5/f≤2.17, and 0.111≤d9/TTL≤0.155, where f5 represents a focal length of the fifth lens, f represents a focal length of the camera optical lens, and d9 represents an on-axis thickness of the fifth lens.

As an improvement, the camera optical lens further satisfies the following condition: TTL/IH≤4.02, where IH represents an image height of 1.0H of the camera optical lens.

The beneficial effects of the present disclosure are: the camera optical lens provided in the present disclosure has excellent optical performance and characteristics of large aperture, ultra-thin, and wide-angle, and is particularly suitable for mobile phone camera lens components and WEB camera lenses composed of camera elements such as charge coupled devices (CCD) or complementary metal-oxide semiconductor sensors (CMOS sensors) with high pixel.

### BRIEF DESCRIPTION OF DRAWINGS

For clearer descriptions of the technical solutions in the embodiments of the present disclosure, drawings that are to be referred for description of the embodiments are briefly described hereinafter. Apparently, the drawings described hereinafter merely illustrate some embodiments of the present disclosure. Persons of ordinary skill in the art can derive other drawings based on the drawings described herein without any creative effort.

FIG. 1 is a schematic diagram of a structure of a camera optical lens according to a first embodiment of the present disclosure.

FIG. 2 is a schematic diagram of a longitudinal aberration of the camera optical lens shown in FIG. 1.

FIG. 3 is a schematic diagram of a lateral color of the camera optical lens shown in FIG. 1.

FIG. 4 is a schematic diagram of a field curvature and a distortion of the camera optical lens shown in FIG. 1.

FIG. 5 is a schematic diagram of a structure of a camera optical lens according to a second embodiment of the present disclosure.

FIG. 6 is a schematic diagram of a longitudinal aberration of the camera optical lens shown in FIG. 5.

FIG. 7 is a schematic diagram of a lateral color of the camera optical lens shown in FIG. 5.

FIG. 8 is a schematic diagram of a field curvature and a distortion of the camera optical lens shown in FIG. 5.

FIG. 9 is a schematic diagram of a structure of a camera optical lens according to a third embodiment of the present disclosure.

FIG. 10 is a schematic diagram of a longitudinal aberration of the camera optical lens shown in FIG. 9.

FIG. 11 is a schematic diagram of a lateral color of the camera optical lens shown in FIG. 9.

FIG. 12 is a schematic diagram of a field curvature and a distortion of the camera optical lens shown in FIG. 9.

FIG. 13 is a schematic diagram of a structure of a camera optical lens according to a fourth embodiment of the present disclosure.

FIG. 14 is a schematic diagram of a longitudinal aberration of the camera optical lens shown in FIG. 13.

FIG. 15 is a schematic diagram of a lateral color of the camera optical lens shown in FIG. 13.

FIG. 16 is a schematic diagram of a field curvature and a distortion of the camera optical lens shown in FIG. 13.

FIG. 17 is a schematic diagram of a structure of a camera optical lens according to a fifth embodiment of the present disclosure.

FIG. 18 is a schematic diagram of a longitudinal aberration of the camera optical lens shown in FIG. 17.

FIG. 19 is a schematic diagram of a lateral color of the camera optical lens shown in FIG. 17.

FIG. 20 is a schematic diagram of a field curvature and a distortion of the camera optical lens shown in FIG. 17.

FIG. 21 is a schematic diagram of a structure of a camera optical lens according to a comparative example of the present disclosure.

FIG. 22 is a schematic diagram of a longitudinal aberration of the camera optical lens shown in FIG. 21.

FIG. 23 is a schematic diagram of a lateral color of the camera optical lens shown in FIG. 21.

FIG. 24 is a schematic diagram of a field curvature and a distortion of the camera optical lens shown in FIG. 21.

### DETAILED DESCRIPTION OF EMBODIMENTS

To make the objects, technical solutions, and advantages of the present disclosure clearer, embodiments of the present disclosure are described in detail with reference to accompanying drawings in the following. A person of ordinary skill in the art can understand that, in the embodiments of the present disclosure, many technical details are provided to make readers better understand the present disclosure. However, even without these technical details and any changes and modifications based on the following embodiments, technical solutions required to be protected by the present disclosure can be implemented.

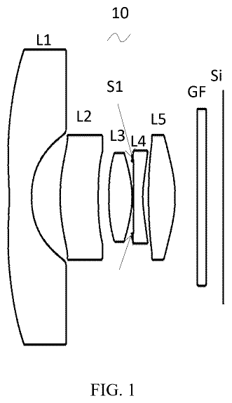

Referring to the drawings, the technical solutions of the present disclosure provide camera optical lenses 10, 20, 30, 40, and 50. FIGS. 1, 5, 9, 13, and 17 show the camera optical lenses 10, 20, 30, 40, and 50 according to the present disclosure, respectively. Each of the camera optical lenses 10, 20, 30, 40, and 50 includes five lenses. Specifically, the camera optical lens includes, from an object side to an image side: a first lens L1 with a negative refractive power, a second lens L2 with a positive refractive power, a third lens L3 with a positive refractive power, a fourth lens L4 with a negative refractive power, and a fifth lens L5 with a positive refractive power.

The focal length of the third lens is defined as f3, the focal length of the fourth lens is defined as f4, and the camera optical lens satisfies a condition of −0.65≤f3/f4≤−0.50. By stipulating a ratio of the focal length of the third lens to the focal length of the fourth lens, the focal lengths of the camera optical lens can be reasonably allocated, and the system can have an excellent imaging quality and a lower sensitivity.

An on-axis thickness of the second lens is defined as d3, an on-axis thickness of the third lens is defined as d5, a total track length of the camera optical lens is defined as TTL, and the camera optical lens satisfies a condition of 0.25≤(d3+d5)/TTL≤0.35. In this way, the on-axis thicknesses of the second lens and the third lens can be reasonably stipulated, which is conducive to reducing the total length of the camera optical system.

A curvature radius of an object side surface of the first lens is defined as R1, a curvature radius of an image side surface of the first lens is defined as R2, the focal length of the first lens is defined as f1, and the camera optical lens satisfies a condition of 1.00≤(R1+R2)/f1≤2.00, Within this range, shapes of surfaces of the first lens can be reasonably controlled, which is conducive to lowering the sensitivity of the system and reducing stray light generated by the lens, thereby improving the imaging quality of the lens.

When the above conditions are satisfied, the camera optical lenses 10, 20, 30, 40, and 50 can have excellent optical performance and meet design requirement of large aperture, ultra-thin, and wide-angle. With the characteristics of the camera optical lenses 10, 20, 30, 40, and 50, they are particularly suitable for mobile phone camera lens components and WEB camera lenses composed of camera elements such as CCDs or CMOS sensors with high pixel.

Based on the above conditions and the functions that can be achieved, characteristics of each lens are illustrated in detail as follows.

A curvature radius of an object side surface of the fifth lens is defined as R9, a curvature radius of an image side surface of the fifth lens is defined as R10, and the camera optical lens satisfies a condition of −4.00≤R9/R10≤−1.50, which stipulates a shape of the fifth lens L5. Within this range, a development towards ultra-thin and wide-angle lenses would facilitate correcting a problem of astigmatism and distortion of the camera lens, thereby controlling the distortion to be less than or equal to 5%.

An edge thickness of the first lens is defined as ET1, an on-axis thickness of the first lens is defined as d1, and the camera optical lens satisfies a condition of 1.81≤ET1/d1≤2.10. A ratio of the edge thickness of the first lens L1 to the on-axis thickness of the first lens is stipulated, which is conducive to the processing and assembly of the lens.

A focal length of the fifth lens is defined as f5, an on-axis thickness of the fifth lens is defined as d9, and the camera optical lens satisfies a condition of 2.00≤f5/d9≤3.00. Within this range, the fifth lens can have sufficient positive refractive power to correct off-axis aberration on the image side, thereby efficiently reducing the total track length, which is conducive to miniaturization of the camera optical lens.

The object side surface of the first lens L1 is concave in a paraxial region, and the image side surface of the first lens is concave in the paraxial region. The object side surface and the image side surface of the first lens L1 may have other concave or convex shapes.

The focal length of the camera optical lens is defined as f, the on-axis thickness of the first lens is defined as d1, and the camera optical lens satisfies a condition of −1.49≤f1/f≤−1.40. A ratio of the negative refractive power of the first lens L1 to the focal length of the camera optical lens is stipulated. Within this range, the first lens can have appropriate negative refractive power, which is conducive to reducing the aberration of the system and to the development of ultra-thin and wide-angle camera lens.

The curvature radius of an object side surface of the first lens L1 is defined as R1, the curvature radius of an image side surface of the first lens L1 is defined as R2, and the camera optical lens satisfies a condition of 0.40≤(R1+R2)/(R1-R2)≤0.57. In this way, the shape of the first lens L1 can be controlled reasonably, such that the first lens L1 can effectively correct a spherical aberration of the system.

The on-axis thickness of the first lens L1 is defined as d1, the total track length of the camera optical lens 10 is defined as TTL, and the camera optical lens satisfies a condition of 0.101≤d1/TTL≤0.118. Within this range, ultra-thin optical camera lens can be achieved.

An object side surface of the second lens L2 is convex in the paraxial region, and an image side surface of the second lens is concave in the paraxial region. The object side surface and the image side surface of the second lens L2 may have other concave or convex shapes.

The focal length of the camera optical lens is defined as f, the focal length of the second lens L2 is defined as f2, and the camera optical lens satisfies a condition of 4.43≤f2/f≤5.49. Controlling the positive focal power of the second lens L2 in a reasonable range is conducive to correction of the aberration of the optical system.

A curvature radius of the object side surface of the second lens L2 is defined as R3, a curvature radius of the image side surface of the second lens L2 is defined as R4, and the camera optical lens satisfies a condition of −2.76≤(R3+R4)/(R3−R4)≤−1.39, which stipulates a shape of the second lens L2. Within this range, a development towards ultra-thin and wide-angle lenses would facilitate correcting a problem of on-axis chromatic aberration.

The on-axis thickness of the second lens L2 is defined as d3, a total track length of the camera optical lens 10 is defined as TTL, and the camera optical lens satisfies a condition of 0.177≤d3/TTL≤0.249. Within this range, ultra-thin optical camera lens can be achieved.

An object side surface of the third lens L3 is convex in the paraxial region, and an image side surface of the third lens is convex in the paraxial region. The object side surface and the image side surface of the third lens L3 may have other concave or convex shapes.

The focal length of the camera optical lens is defined as f, the focal length of the third lens L3 is defined as f3, and the camera optical lens satisfies a condition of 1.60≤f3/f≤1.71. With the reasonable allocation of the focal power, the system can have an excellent imaging quality and a lower sensitivity.

A curvature radius of an object side surface of the third lens L3 is defined as R5, a curvature radius of an image side surface of the third lens L3 is defined as R6, and the camera optical lens satisfies a condition of 0.24≤(R5+R6)/(R5-R6)≤0.38, which stipulates a shape of the third lens L3 and facilitates formation of the third lens L3. Within this range, a degree of deflection of light passing through the lens can be alleviated, and aberrations can be reduced effectively.

The on-axis thickness of the third lens L3 is defined as d5, the total track length of the camera optical lens 10 is defined as TTL, and the camera optical lens satisfies a condition of 0.049≤d5/TTL≤0.109. Within this range, ultra-thin optical camera lens can be achieved.

The object side surface of the fourth lens L4 is convex in the paraxial region, and the image side surface of the fourth lens L4 is concave in the paraxial region. The object side surface and the image side surface of the fourth lens L4 may have other concave or convex shapes.

The focal length of the camera optical lens is defined as f, a focal length of the fourth lens L4 is defined as f4, and the camera optical lens satisfies a condition of −3.27≤f4/f≤−2.57. With the reasonable allocation of the focal power, the system can have an excellent imaging quality and a lower sensitivity.

A curvature radius of the object side surface of the fourth lens L4 is defined as R7, a curvature radius of an image side surface of the fourth lens L4 is defined as R8, and the camera optical lens satisfies a condition of 2.42≤(R7+R8)/(R7-R8)≤3.00, which stipulates a shape of the fourth lens L4. Within this range, a development towards ultra-thin and wide-angle lenses would facilitate correcting a problem of an off-axis aberration.

The on-axis thickness of the fourth lens L4 is defined as d7, the total track length of the camera optical lens 10 is defined as TTL, and the camera optical lens satisfies a condition of 0.040≤d7/TTL≤0.045. Within this range, ultra-thin optical camera lens can be achieved.

An object side surface of the fifth lens L5 is convex in the paraxial region, and an image side surface of the fifth lens is convex in the paraxial region. The object side surface and the image side surface of the fifth lens L5 may have other concave or convex shapes.

The focal length of the camera optical lens 10 is defined as f, a focal length of the fifth lens L5 is defined as f5, and the camera optical lens satisfies a condition of 1.92≤f5/f≤2.17. By defining the fifth lens L5, a light angle for the camera optical lens 10 can be smoothed effectively and a tolerance sensitivity can be reduced.

The on-axis thickness of the fifth lens L5 is defined as d9, the total track length of the camera optical lens 10 is defined as TTL, and the camera optical lens satisfies a condition of 0.111≤d9/TTL≤0.155. Within this range, ultra-thin optical camera lens can be achieved.

The total track length of the camera optical lens is defined as TTL, an image height of 1.0H of the camera optical lens is defined as IH, and the camera optical lens satisfies a condition of TTL/IH≤4.02.

The first lens L1, the second lens L2, the third lens L3, the fourth lens L4, and the fifth lens L5 are all made of plastic material. In other embodiments, each lens may be made of another material, respectively.

In the present disclosure, an optical element such as an optical filter GF may be arranged between the fifth lens L5 and an image surface Si. The optical filter GF may be implemented as a glass plate or an optical filter. The optical filter GF may also be arranged at other positions.

In the present disclosure, an aperture S1 may be arranged between the third lens L3 and the fourth lens L4. The aperture S1 may also be arranged at other positions.

In the following, embodiments will be used to describe the camera optical lens of the present disclosure. The symbols recorded in each embodiment will be described as follows. The focal length, on-axis distance, curvature radius, and on-axis thickness are all in units of mm.

TTL: total track length (the on-axis distance from the object side surface of the first lens L1 to the image surface S1 of the camera optical lens along the optical axis) in unit of mm.

The F number (FNO) refers to a ratio of an effective focal length of the camera optical lens to an entrance pupil diameter (ENPD).

The image height of 1.0H (IH): a height of the field of view corresponding to the effective pixels of the sensor (i.e. a half of the diagonal length of the effective pixel area of the sensor).

The field of view (FOV) of 1.0H: a field of view corresponding to the effective pixels of the sensor.

The image height at MIC field position (IHm): a height of the field of view that is expanded from 1.0H and configured to prevent assembly deviation.

The field of view under MIC conditions (FOVm): a field of view corresponding to the image height at MIC field position.

In the following, the technical solutions of the present disclosure are illustrated in detail with reference to five embodiments, and at the same time, a comparative example is provided as a reference. The technical effect of the present disclosure cannot be achieved beyond the scope of the conditions as illustrated above.

### First Embodiment

Table 1 and Table 2 show design data of the camera optical lens 10 according to the first embodiment of the present disclosure.

TABLE 1

| | R | d | | nd | | vd | |
|---|---|---|---|---|---|---|---|
| S1 | ∞ | d0 = | −2.847 | | | | |
| R1 | −2.514 | d1 = | 0.518 | nd1 | 1.5444 | vd1 | 55.82 |
| R2 | 0.868 | d2 = | 0.660 | | | | |
| R3 | 1.492 | d3 = | 0.879 | nd2 | 1.6700 | vd2 | 19.39 |
| R4 | 3.196 | d4 = | 0.247 | | | | |
| R5 | 2.167 | d5 = | 0.539 | nd3 | 1.5452 | vd3 | 55.09 |
| R6 | −0.979 | d6 = | 0.029 | | | | |
| R7 | 1.670 | d7 = | 0.218 | nd4 | 1.6700 | vd4 | 19.39 |
| R8 | 0.750 | d8 = | 0.135 | | | | |
| R9 | 2.982 | d9 = | 0.614 | nd5 | 1.5444 | vd5 | 55.82 |
| R10 | −1.037 | d10 = | 0.510 | | | | |
| R11 | ∞ | d11 = | 0.210 | ndg | 1.5168 | vdg | 64.17 |
| R12 | ∞ | d12 = | 0.396 | | | | |

Herein, meanings of various symbols will be described as follows.
S1: aperture.
R: curvature radius of an optical surface, a central curvature radius for a lens.
R1: curvature radius of the object side surface of the first lens L1.
R2: curvature radius of the image side surface of the first lens L1.
R3: curvature radius of the object side surface of the second lens L2.
R4: curvature radius of the image side surface of the second lens L2.
R5: curvature radius of the object side surface of the third lens L3.
R6: curvature radius of the image side surface of the third lens L3.
R7: curvature radius of the object side surface of the fourth lens L4.
R8: curvature radius of the image side surface of the fourth lens L4.
R9: curvature radius of the object side surface of the fifth lens L5.
R10: curvature radius of the image side surface of the fifth lens L5.
R11: curvature radius of an object side surface of the optical filter (GF).
R12: curvature radius of an image side surface of the optical filter (GF).
d: on-axis thickness of a lens and an on-axis distance between lenses.
d0: on-axis distance from the aperture S1 to the object side surface of the first lens L1.
d1: on-axis thickness of the first lens L1.
d2: on-axis distance from the image side surface of the first lens L1 to the object side surface of the second lens L2.
d3: on-axis thickness of the second lens L2.
d4: on-axis distance from the image side surface of the second lens L2 to the object side surface of the third lens L3.
d5: on-axis thickness of the third lens L3.
d6: on-axis distance from the image side surface of the third lens L3 to the object side surface of the fourth lens L4.
d7: on-axis thickness of the fourth lens L4.
d8: on-axis distance from the image side surface of the fourth lens L4 to the object side surface of the fifth lens L5.
d9: on-axis thickness of the fifth lens L5.
d10: on-axis distance from the image side surface of the fifth lens L5 to the object side surface of the optical filter (GF).
d11: on-axis thickness of the optical filter (GF).
d12: on-axis distance from the image side surface of the optical filter (GF) to the image surface Si.
nd: refractive index of a d line.
nd1: refractive index of the d line of the first lens L1.
nd2: refractive index of the d line of the second lens L2.
nd3: refractive index of the d line of the third lens L3.
nd4: refractive index of the d line of the fourth lens L4.
nd5: refractive index of the d line of the fifth lens L5.
ndg: refractive index of the d line of the optical filter (GF).
vd: abbe number.
vd1: abbe number of the first lens L1.
vd2: abbe number of the second lens L2.
vd3: abbe number of the third lens L3.
vd4: abbe number of the fourth lens L4.
vd5: abbe number of the fifth lens L5.
vdg: abbe number of the optical filter (GF).

Table 2 shows aspherical surface data of each lens of the camera optical lens 10 in the First Embodiment of the present disclosure.

TABLE 2

| | Conic | Aspheric surface coefficients | | | | | | |
|---|---|---|---|---|---|---|---|---|
| | k | A4 | A6 | A8 | A10 | A12 | A14 | A16 |
| R1 | 9.7157E− | 6.5853E−01 | −1.3406E+00 | 2.2731E+00 | −2.9409E+00 | 2.8409E+00 | — | 1.0993E+00 |
| R2 | — | 7.6870E−01 | 6.3378E+00 | −1.4835E+02 | 1.7170E+03 | −1.2893E+04 | 6.6750E+04 | — |
| R3 | — | 7.9936E−02 | −2.1158E+00 | 3.5712E+01 | −3.9722E+02 | 2.8987E+03 | — | 4.9779E+04 |
| R4 | — | 2.3192E−01 | −1.6962E+00 | 3.0903E+01 | −3.2556E+02 | 2.1554E+03 | — | 2.5260E+04 |
| R5 | 8.8051E− | 1.8016E−01 | 3.3034E+00 | −8.7826E+01 | 1.4993E+03 | −1.6702E+04 | 1.2460E+05 | — |
| R6 | −2.9059E− | −4.6633E+00 | 1.4802E+02 | −2.6762E+03 | 3.3036E+04 | −2.7862E+05 | 1.5285E+06 | — |
| R7 | — | −6.7951E+00 | 1.4378E+02 | −2.3373E+03 | 2.7823E+04 | −2.4000E+05 | 1.4853E+06 | — |
| R8 | −9.7039E− | −4.3054E+00 | 4.0181E+01 | −3.2524E+02 | 2.0290E+03 | −9.3059E+03 | 3.0415E+04 | — |
| R9 | 4.5692E+0 | −8.2772E−01 | 4.9335E+00 | −1.9401E+01 | 7.3280E+01 | −3.2242E+02 | 1.4209E+03 | — |
| R10 | — | 1.3413E−01 | −5.9954E+00 | 9.3188E+01 | −8.6657E+02 | 5.3652E+03 | — | 7.0268E+04 |

| | Conic | Aspheric surface coefficients | | | | | | |
|---|---|---|---|---|---|---|---|---|
| | k | A18 | A20 | A22 | A24 | A26 | A28 | A30 |
| R1 | 9.7157E−03 | −4.4117E−01 | 1.3134E−01 | −2.8557E−02 | 4.4014E−03 | −4.5516E−04 | 2.8308E−05 | −7.9995E− |
| R2 | −1.0646E+00 | 6.4765E+05 | — | 1.6820E+06 | −1.5967E+06 | 1.0028E+06 | −3.7433E+05 | 6.2854E+04 |
| R3 | −2.3216E+00 | −1.2131E+05 | 2.0756E+05 | — | 1.8789E+05 | — | 1.7278E+04 | 0.0000E+00 |
| R4 | −5.2978E+00 | −4.3078E+04 | 4.1400E+04 | — | 0.0000E+00 | 0.0000E+00 | 0.0000E+00 | 0.0000E+00 |
| R5 | 8.8051E−01 | 2.1970E+06 | — | 7.6969E+06 | −6.7167E+06 | 2.5894E+06 | 0.0000E+00 | 0.0000E+00 |
| R6 | −2.9059E−01 | −2.4399E+06 | 8.7356E+07 | — | 1.0619E+09 | — | 1.4229E+09 | — |
| R7 | −3.6655E+00 | 1.9583E+07 | — | 4.4625E+07 | −2.2987E+07 | 0.0000E+00 | 0.0000E+00 | 0.0000E+00 |
| R8 | −9.7039E−01 | 1.0343E+05 | — | 4.7393E+04 | −8.3574E+03 | 0.0000E+00 | 0.0000E+00 | 0.0000E+00 |
| R9 | 4.5692E+00 | 1.3843E+04 | — | 3.4103E+04 | −2.8498E+04 | 1.3820E+04 | −2.9493E+03 | 0.0000E+00 |
| R10 | −3.5990E+00 | −1.5455E+05 | 2.4567E+05 | — | 2.2181E+05 | — | 3.6432E+04 | — |

For convenience, an aspheric surface of each lens surface uses the aspheric surfaces as expressed in the following condition (1). However, the present disclosure is not limited to the aspherical polynomials form as expressed in the condition (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} \qquad ( 1 )$$

Herein, K is a conic coefficient, A4, A6, A8, A10, A12, A14, A16, A18, A20, A22, A24, A26, A28, and A30 are aspheric surface coefficients, c is a curvature of an optical surface or a central curvature for a lens, r is a vertical distance between a point on an aspheric curve and the optical axis, and z is a depth of the aspheric surface (the vertical distance between a point on the aspheric surface from which a vertical distance to the optical axis is r and a tangent plane tangent to a vertex on the optical axis of the aspheric surface).

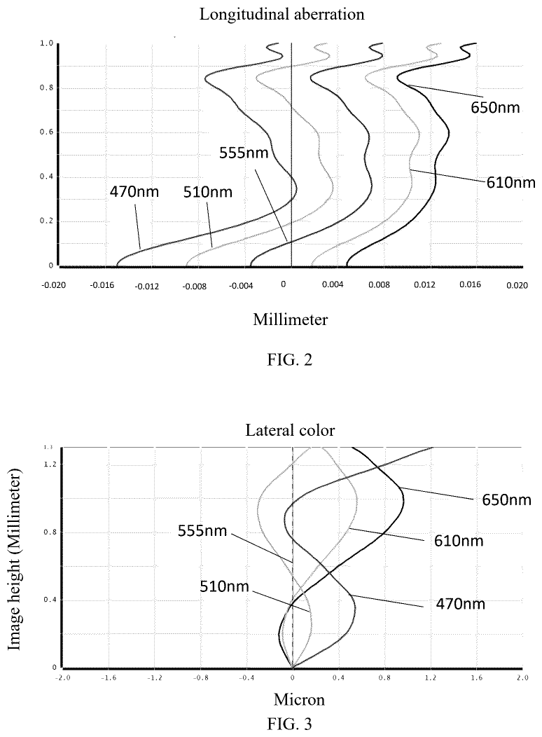

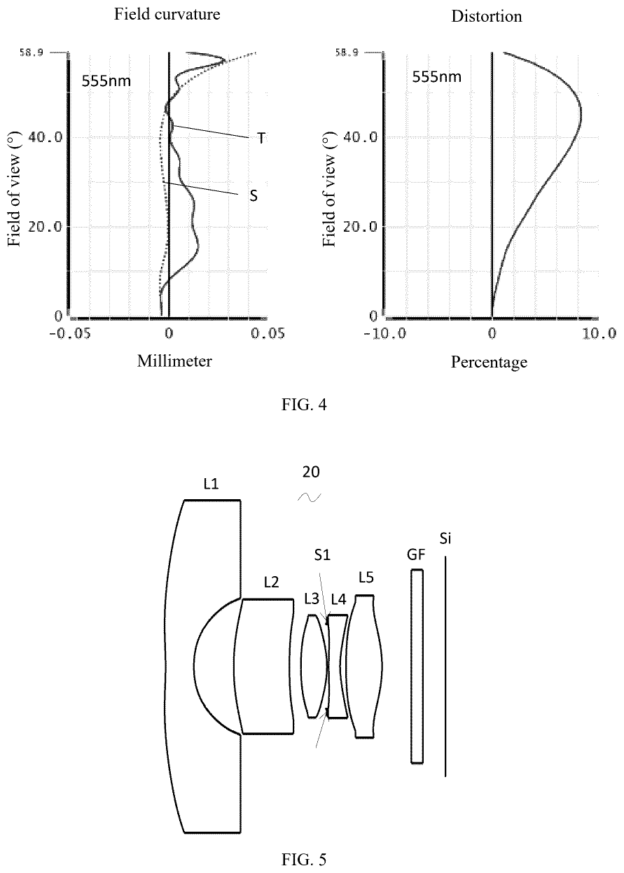

FIG. 2 and FIG. 3 illustrate a longitudinal aberration and a lateral color of the camera optical lens 10 according to the First Embodiment after light with wavelengths of 650 nm, 610 nm, 555 nm, 510 nm, and 470 nm passing through the camera optical lens 10, respectively. FIG. 4 illustrates a field curvature and a distortion of the camera optical lens 10 after light with a wavelength of 555 nm passing through the camera optical lens 10 according to the First Embodiment. A field curvature S in FIG. 4 is a field curvature in a sagittal direction, and T is a field curvature in a tangential direction.

In the embodiment, an entrance pupil diameter (ENPD) of the camera optical lens 10 is 0.548 mm, an image height IH of 1.0H is 1.30 mm, a field of view FOV of 1.0H is 117.82°, an image height at MIC field position (IHm) is 1.40 mm, a field of view under MIC conditions (FOVm) is 123.77°. Thus, the camera optical lens 10 can meet the design requirements of a large aperture, a wide angle, and ultra-thin, and its on-axis and off-axis chromatic aberrations are fully corrected, thereby achieving excellent optical characteristics.

### Second Embodiment

The symbols in the Second Embodiment have the same meanings as those in the First Embodiment.

FIG. 5 shows the camera optical lens 20 according to the Second Embodiment of the present disclosure.

Table 3 and Table 4 show design data of the camera optical lens 20 according to the Second Embodiment of the present disclosure.

TABLE 3

| | R | d | | nd | | vd | |
|---|---|---|---|---|---|---|---|
| S1 | ∞ | d0 = | −2.952 | | | | |
| R1 | −2.933 | d1 = | 0.519 | nd1 | 1.5439 | vd1 | 55.95 |
| R2 | 0.816 | d2 = | 0.730 | | | | |
| R3 | 1.855 | d3 = | 1.020 | nd2 | 1.6700 | vd2 | 19.39 |
| R4 | 4.342 | d4 = | 0.210 | | | | |
| R5 | 1.868 | d5 = | 0.476 | nd3 | 1.5441 | vd3 | 56.04 |
| R6 | −1.014 | d6 = | 0.033 | | | | |
| R7 | 1.712 | d7 = | 0.208 | nd4 | 1.6700 | vd4 | 19.39 |
| R8 | 0.712 | d8 = | 0.109 | | | | |
| R9 | 2.583 | d9 = | 0.660 | nd5 | 1.5439 | vd5 | 55.95 |
| R10 | −1.057 | d10 = | 0.539 | | | | |
| R11 | ∞ | d11 = | 0.210 | ndg | 1.5168 | vdg | 64.17 |
| R12 | ∞ | d12 = | 0.412 | | | | |

Table 4 shows aspherical surface data of each lens of the camera optical lens 20 in the Second Embodiment of the present disclosure.

TABLE 4

| | |
|---|---|
| Conic | Aspheric surface coefficients |

| | k | A4 | A6 | A8 | A10 | A12 | A14 | A16 |
|---|---|---|---|---|---|---|---|---|
| R1 | 2.0390E−02 | 6.4126E−01 | −1.3389E+00 | 2.2734E+00 | −2.9409E+00 | 2.8408E+00 | — | 1.0993E+00 |
| R2 | — | 8.9221E−01 | 6.2287E+00 | −1.4816E+02 | 1.7171E+03 | −1.2894E+04 | 6.6749E+04 | — |
| R3 | — | 6.3647E−02 | −1.8814E+00 | 3.5082E+01 | −3.9641E+02 | 2.8988E+03 | — | 4.9779E+04 |
| R4 | — | 2.4397E−01 | −1.3547E+00 | 2.7242E+01 | −3.2093E+02 | 2.2223E+03 | — | 2.6223E+04 |
| R5 | 8.5939E−01 | 3.2842E−01 | 2.2148E+00 | −8.4298E+01 | 1.4931E+03 | −1.6710E+04 | 1.2471E+05 | — |
| R6 | −2.6969E− | — | 1.4792E+02 | −2.6755E+03 | 3.3036E+04 | −2.7862E+05 | 1.5285E+06 | — |
| R7 | — | — | 1.4434E+02 | −2.3401E+03 | 2.7832E+04 | −2.3995E+05 | 1.4850E+06 | — |
| R8 | −9.5710E− | — | 4.0263E+01 | −3.2528E+02 | 2.0269E+03 | −9.3007E+03 | 3.0416E+04 | — |
| R9 | 5.1011E+00 | −5.5518E−01 | 4.9425E+00 | −2.0251E+01 | 7.3185E+01 | −3.2104E+02 | 1.4295E+03 | — |
| R10 | — | 1.9361E−01 | −5.9438E+00 | 9.3419E+01 | −8.6689E+02 | 5.3655E+03 | — | 7.0268E+04 |

| | Conic | Aspheric surface coefficients | | | | | | |
|---|---|---|---|---|---|---|---|---|
| | k | A18 | A20 | A22 | A24 | A26 | A28 | A30 |
| R1 | 2.0390E−02 | −4.4117E−01 | 1.3134E−01 | −2.8556E−02 | 4.4014E−03 | −4.5516E−04 | 2.8306E−05 | −7.9968E− |
| R2 | — | 6.4764E+05 | — | 1.6820E+06 | −1.5967E+06 | 1.0028E+06 | −3.7432E+05 | 6.2845E+04 |
| R3 | — | −1.2131E+05 | 2.0756E+05 | — | 1.8789E+05 | — | 1.7294E+04 | — |
| R4 | — | −4.4071E+04 | 4.1476E+04 | — | 0.0000E+00 | 0.0000E+00 | 0.0000E+00 | 0.0000E+00 |
| R5 | 8.5939E−01 | 2.1972E+06 | — | 7.6983E+06 | −6.7191E+06 | 2.5849E+06 | 0.0000E+00 | 0.0000E+00 |
| R6 | −2.6969E− | −2.4399E+06 | 8.7356E+07 | — | 1.0619E+09 | — | 1.4229E+09 | — |
| R7 | — | 1.9587E+07 | — | 4.4576E+07 | −2.2933E+07 | 0.0000E+00 | 0.0000E+00 | 0.0000E+00 |
| R8 | −9.5710E− | 1.0338E+05 | — | 4.8091E+04 | −9.1668E+03 | 0.0000E+00 | 0.0000E+00 | 0.0000E+00 |
| R9 | 5.1011E+00 | 1.3846E+04 | — | 3.4110E+04 | −2.8516E+04 | 1.3824E+04 | −2.9530E+03 | 0.0000E+00 |
| R10 | — | −1.5455E+05 | 2.4566E+05 | — | 2.2182E+05 | — | 3.6421E+04 | — |

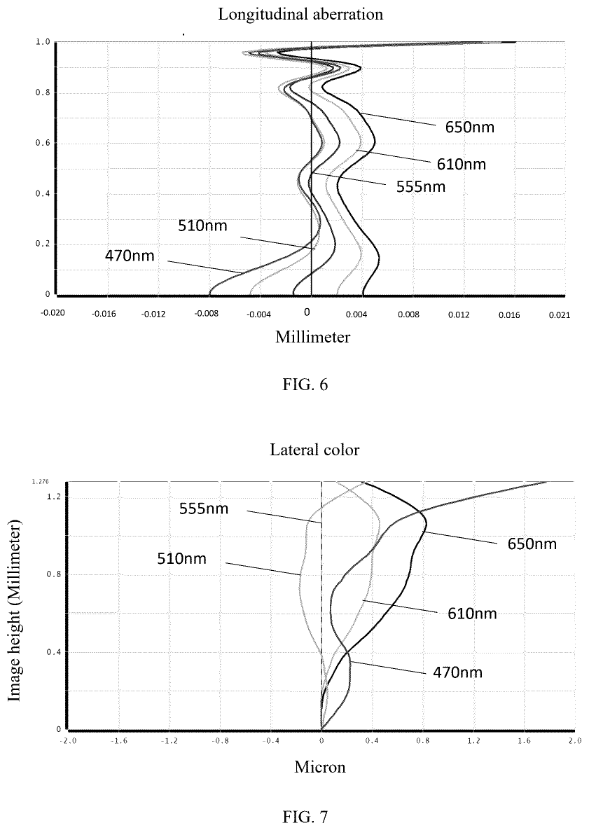

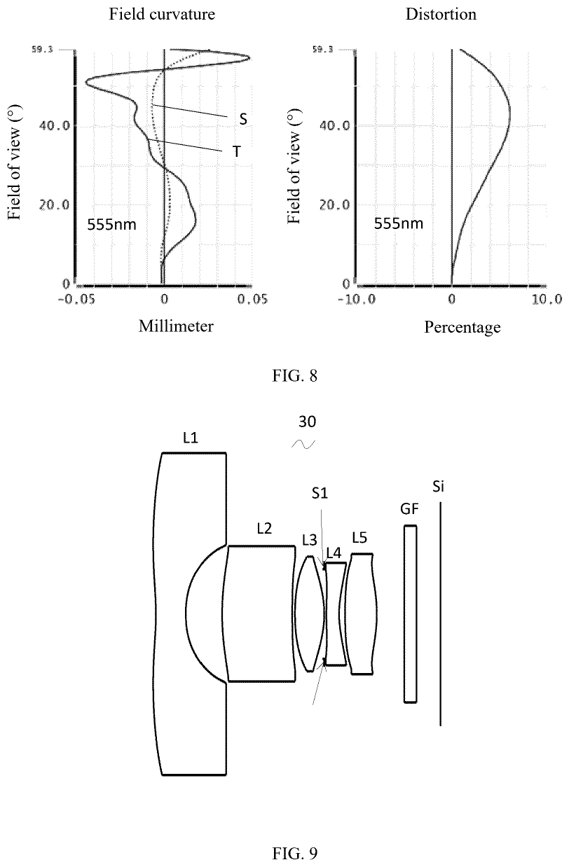

FIG. 6 and FIG. 7 illustrate a longitudinal aberration and a lateral color of the camera optical lens 20 according to the Second Embodiment after light with wavelengths of 650 nm, 610 nm, 555 nm, 510 nm, and 470 nm passing through the camera optical lens 20, respectively. FIG. 8 illustrates a field curvature and a distortion of the camera optical lens 20 after light with a wavelength of 555 nm passing through the camera optical lens 20 according to the Second Embodiment. A field curvature S in FIG. 8 is a field curvature in a sagittal direction, and T is a field curvature in a tangential direction.

In the embodiment, an entrance pupil diameter (ENPD) of the camera optical lens 20 is 0.531 mm, an image height IH of 1.0H is 1.27 mm, a field of view FOV of 1.0H is 118.51°, an image height at MIC field position (IHm) is 1.39 mm, a field of view under MIC conditions (FOVm) is 123.90°. Thus, the camera optical lens 20 can meet the design requirements of a large aperture, a wide angle, and ultra-thin, and its on-axis and off-axis chromatic aberrations are fully corrected, thereby achieving excellent optical characteristics.

### Third Embodiment

The symbols in the Third Embodiment have the same meanings as those in the First Embodiment.

FIG. 9 shows the camera optical lens 30 according to the Third Embodiment of the present disclosure.

Table 5 and Table 6 show design data of a camera optical lens 30 according to the Third Embodiment of the present disclosure.

TABLE 5

| | R | d | | nd | | νd | |
|---|---|---|---|---|---|---|---|
| S1 | ∞ | do = | −2.881 | | | | |
| R1 | −2.035 | d1 = | 0.511 | nd1 | 1.5439 | v1 | 55.95 |
| R2 | 0.869 | d2 = | 0.623 | | | | |
| R3 | 2.058 | d3 = | 1.201 | nd2 | 1.6700 | v2 | 19.39 |
| R4 | 12.423 | d4 = | 0.047 | | | | |
| R5 | 1.648 | d5 = | 0.500 | nd3 | 1.5441 | v3 | 56.04 |
| R6 | −0.980 | d6 = | 0.037 | | | | |
| R7 | 1.623 | d7 = | 0.217 | nd4 | 1.6700 | v4 | 19.39 |
| R8 | 0.685 | d8 = | 0.103 | | | | |
| R9 | 3.206 | d9 = | 0.544 | nd5 | 1.5439 | v5 | 55.95 |
| R10 | −1.134 | d10 = | 0.472 | | | | |
| R11 | ∞ | d11 = | 0.210 | ndg | 1.5168 | vdg | 64.17 |
| R12 | ∞ | d12 = | 0.408 | | | | |

Table 6 shows aspherical surface data of each lens of the camera optical lens 30 in the Third Embodiment of the present disclosure.

TABLE 6

| | Conic | Aspheric surface coefficients | | | | | | |
|---|---|---|---|---|---|---|---|---|
| | k | A4 | A6 | A8 | A10 | A12 | A14 | A16 |
| R1 | −5.8352E− | 6.6544E−01 | −1.3393E+00 | 2.2735E+00 | −2.9409E+00 | 2.8409E+00 | — | 1.0993E+00 |
| R2 | −9.8242E− | 7.6905E−01 | 7.0021E+00 | −1.5267E+02 | 1.7355E+03 | −1.2929E+04 | 6.6762E+04 | — |
| R3 | — | 8.6510E−02 | −2.0392E+00 | 3.5545E+01 | −3.9738E+02 | 2.8992E+03 | — | 4.9779E+04 |
| R4 | — | 3.3218E−01 | −1.9339E+00 | 3.0393E+01 | −3.2472E+02 | 2.1578E+03 | — | 2.5264E+04 |
| R5 | 2.1374E+00 | 3.3376E−01 | 2.6160E+00 | −8.7591E+01 | 1.5010E+03 | −1.6702E+04 | 1.2460E+05 | — |
| R6 | −2.1315E− | — | 1.4810E+02 | −2.6749E+03 | 3.3035E+04 | −2.7862E+05 | 1.5285E+06 | — |
| R7 | — | — | 1.4326E+02 | −2.3349E+03 | 2.7824E+04 | −2.4000E+05 | 1.4852E+06 | — |
| R8 | −7.3768E− | — | 3.9865E+01 | −3.2751E+02 | 2.0454E+03 | −9.3677E+03 | 3.0503E+04 | — |
| R9 | 1.5820E+01 | −3.0549E−01 | 5.0200E+00 | −2.1401E+01 | 7.1847E+01 | −3.1853E+02 | 1.4324E+03 | — |
| R10 | — | 3.5875E−01 | −6.0323E+00 | 9.6098E+01 | −8.7256E+02 | 5.3639E+03 | — | 7.0227E+04 |

| | Conic | Aspheric surface coefficients | | | | | | |
|---|---|---|---|---|---|---|---|---|
| | k | A18 | A20 | A22 | A24 | A26 | A28 | A30 |
| R1 | −5.8352E− | −4.4117E−01 | 1.3134E−01 | −2.8557E−02 | 4.4014E−03 | −4.5516E−04 | 2.8308E−05 | −7.9997E− |
| R2 | −9.8242E− | 6.4763E+05 | — | 1.6818E+06 | −1.5966E+06 | 1.0033E+06 | −3.7495E+05 | 6.3016E+04 |
| R3 | — | −1.2132E+05 | 2.0756E+05 | — | 1.8791E+05 | — | 1.7176E+04 | 3.3405E+01 |
| R4 | — | −4.3152E+04 | 4.1447E+04 | — | 0.0000E+00 | 0.0000E+00 | 0.0000E+00 | 0.0000E+00 |
| R5 | 2.1374E+00 | 2.1970E+06 | — | 7.6969E+06 | −6.7165E+06 | 2.5888E+06 | 0.0000E+00 | 0.0000E+00 |
| R6 | −2.1315E− | −2.4398E+06 | 8.7356E+07 | — | 1.0619E+09 | — | 1.4229E+09 | — |
| R7 | — | 1.9584E+07 | — | 4.4616E+07 | −2.2984E+07 | 0.0000E+00 | 0.0000E+00 | 0.0000E+00 |
| R8 | −7.3768E− | 1.0327E+05 | — | 4.7204E+04 | −7.2344E+03 | 0.0000E+00 | 0.0000E+00 | 0.0000E+00 |
| R9 | 1.5820E+01 | 1.3845E+04 | — | 3.4104E+04 | −2.8732E+04 | 1.3887E+04 | −2.3049E+03 | 0.0000E+00 |
| R10 | — | −1.5458E+05 | 2.4569E+05 | — | 2.2178E+05 | — | 3.5822E+04 | — |

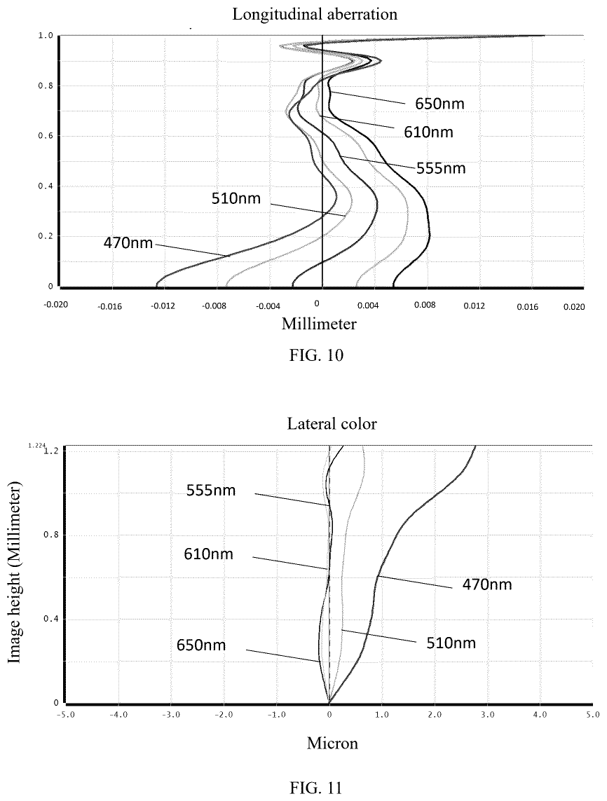

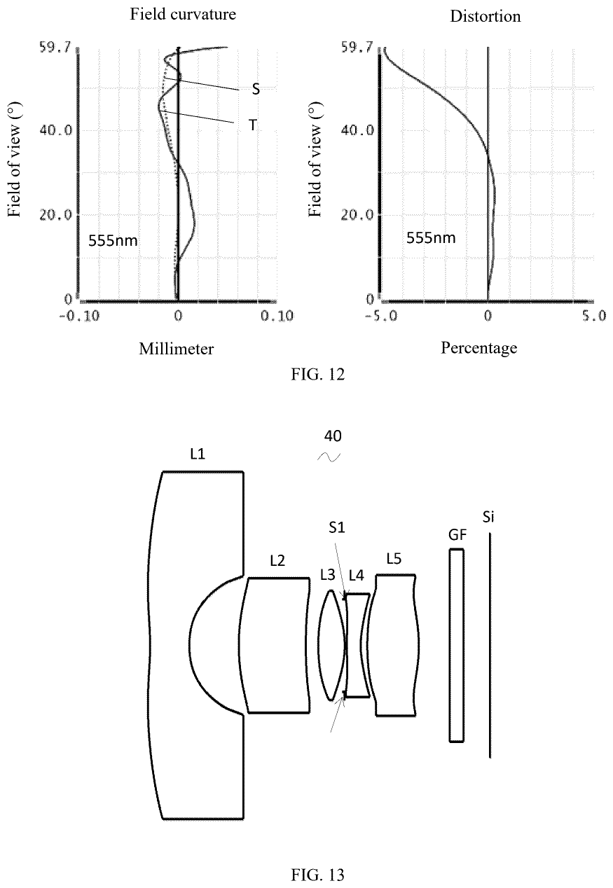

FIG. 10 and FIG. 11 illustrate a longitudinal aberration and a lateral color of the camera optical lens 30 according to the Third Embodiment after light with wavelengths of 650 nm, 610 nm, 555 nm, 510 nm, and 470 nm passing through the camera optical lens 30, respectively. FIG. 12 illustrates a field curvature and a distortion of the camera optical lens 30 after light with a wavelength of 555 nm passing through the camera optical lens 30 according to the Third Embodiment. A field curvature S in FIG. 12 is a field curvature in a sagittal direction, and T is a field curvature in a tangential direction.

In the embodiment, an entrance pupil diameter (ENPD) of the camera optical lens 30 is 0.532 mm, an image height IH of 1.0H is 1.22 mm, a field of view FOV of 1.0H is 119.31°, an image height at MIC field position (IHm) is 1.40 mm, a field of view under MIC conditions (FOVm) is 125.17°. Thus, the camera optical lens 30 can meet the design requirements of a large aperture, a wide angle, and ultra-thin, and its on-axis and off-axis chromatic aberrations are fully corrected, thereby achieving excellent optical characteristics.

### Fourth Embodiment

The symbols in the Fourth Embodiment have the same meanings as those in the First Embodiment.

FIG. 13 shows the camera optical lens 40 according to the Fourth Embodiment of the present disclosure.

Table 7 and Table 8 show design data of the camera optical lens 40 according to the Fourth Embodiment of the present disclosure.

TABLE 7

| | R | d | | nd | | νd | |
|---|---|---|---|---|---|---|---|
| S1 | ∞ | d0 = | −2.828 | | | | |
| R1 | −2.272 | d1 = | 0.590 | nd1 | 1.5439 | v1 | 55.95 |
| R2 | 0.821 | d2 = | 0.746 | | | | |
| R3 | 1.826 | d3 = | 1.011 | nd2 | 1.6700 | v2 | 19.39 |
| R4 | 4.793 | d4 = | 0.237 | | | | |
| R5 | 1.727 | d5 = | 0.248 | nd3 | 1.5441 | v3 | 56.04 |
| R6 | −1.041 | d6 = | 0.031 | | | | |
| R7 | 1.670 | d7 = | 0.209 | nd4 | 1.6700 | v4 | 19.39 |
| R8 | 0.705 | d8 = | 0.100 | | | | |
| R9 | 1.947 | d9 = | 0.777 | nd5 | 1.5439 | v5 | 55.95 |
| R10 | −1.293 | d10 = | 0.462 | | | | |
| R11 | ∞ | d11 = | 0.210 | ndg | 1.5168 | vdg | 64.17 |
| R12 | ∞ | d12 = | 0.402 | | | | |

Table 8 shows aspherical surface data of each lens of the camera optical lens 40 in the Fourth Embodiment of the present disclosure.

TABLE 8

| | |
|---|---|
| Conic | Aspheric surface coefficients |

| | k | A4 | A6 | A8 | A10 | A12 | A14 | A16 |
|---|---|---|---|---|---|---|---|---|
| R1 | 3.4285E−02 | 6.5970E−01 | −1.3415E+00 | 2.2740E+00 | −2.9410E+00 | 2.8409E+00 | — | 1.0993E+00 |
| R2 | −7.7783E− | 8.8403E−01 | 6.2763E+00 | −1.4808E+02 | 1.7168E+03 | −1.2893E+04 | 6.6750E+04 | — |
| R3 | — | 9.9258E−02 | −2.1218E+00 | 3.5696E+01 | −3.9716E+02 | 2.8985E+03 | — | 4.9779E+04 |
| R4 | — | 2.0977E−01 | −1.7814E+00 | 3.0803E+01 | −3.2642E+02 | 2.1558E+03 | — | 2.5275E+04 |
| R5 | 1.1882E+00 | 2.4781E−01 | 3.1416E+00 | −8.8378E+01 | 1.4992E+03 | −1.6712E+04 | 1.2464E+05 | — |
| R6 | −1.3681E− | — | 1.4802E+02 | −2.6762E+03 | 3.3036E+04 | −2.7862E+05 | 1.5285E+06 | — |
| R7 | — | — | 1.4340E+02 | −2.3354E+03 | 2.7824E+04 | −2.4000E+05 | 1.4853E+06 | — |
| R8 | −9.1205E− | — | 4.0280E+01 | −3.2520E+02 | 2.0290E+03 | −9.3068E+03 | 3.0417E+04 | — |
| R9 | 6.4694E+00 | −5.5078E−01 | 4.7699E+00 | −2.0298E+01 | 7.0771E+01 | −3.1966E+02 | 1.4270E+03 | — |
| R10 | — | 2.9713E−01 | −5.6797E+00 | 9.2843E+01 | −8.6578E+02 | 5.3644E+03 | — | 7.0267E+04 |

| | Conic | Aspheric surface coefficients | | | | | | |
|---|---|---|---|---|---|---|---|---|
| | k | A18 | A20 | A22 | A24 | A26 | A28 | A30 |
| R1 | 3.4285E−02 | −4.4117E−01 | 1.3134E−01 | −2.8557E−02 | 4.4014E−03 | −4.5516E−04 | 2.8308E−05 | −7.9990E− |
| R2 | −7.7783E− | 6.4765E+05 | — | 1.6820E+06 | −1.5967E+06 | 1.0028E+06 | −3.7433E+05 | 6.2890E+04 |
| R3 | — | −1.2131E+05 | 2.0756E+05 | — | 1.8789E+05 | — | 1.7266E+04 | — |
| R4 | — | −4.3072E+04 | 4.1276E+04 | — | 0.0000E+00 | 0.0000E+00 | 0.0000E+00 | 0.0000E+00 |
| R5 | 1.1882E+00 | 2.1972E+06 | — | 7.6953E+06 | −6.7168E+06 | 2.5954E+06 | 0.0000E+00 | 0.0000E+00 |
| R6 | −1.3681E− | −2.4398E+06 | 8.7356E+07 | — | 1.0619E+09 | — | 1.4229E+09 | — |
| R7 | — | 1.9583E+07 | — | 4.4625E+07 | −2.2977E+07 | 0.0000E+00 | 0.0000E+00 | 0.0000E+00 |
| R8 | −9.1205E− | 1.0342E+05 | — | 4.7277E+04 | −8.6538E+03 | 0.0000E+00 | 0.0000E+00 | 0.0000E+00 |
| R9 | 6.4694E+00 | 1.3837E+04 | — | 3.4087E+04 | −2.8617E+04 | 1.3764E+04 | −3.3969E+03 | 0.0000E+00 |
| R10 | — | −1.5456E+05 | 2.4567E+05 | — | 2.2181E+05 | — | 3.6438E+04 | — |

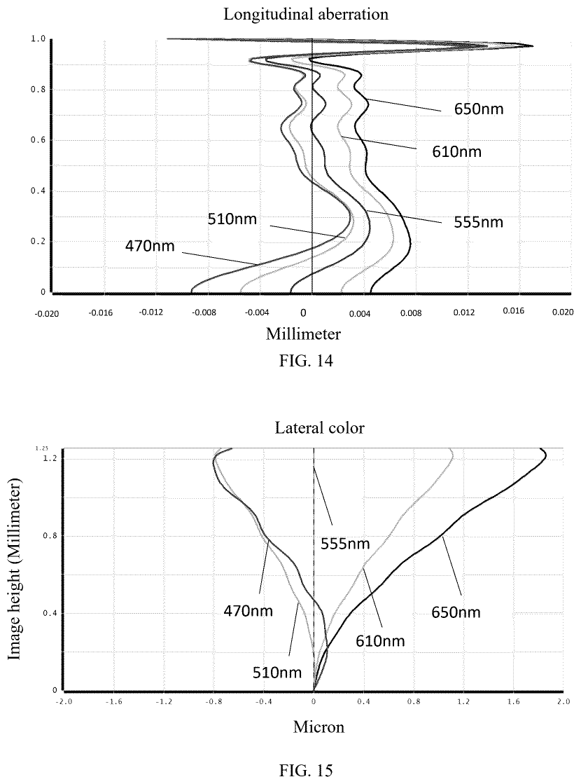

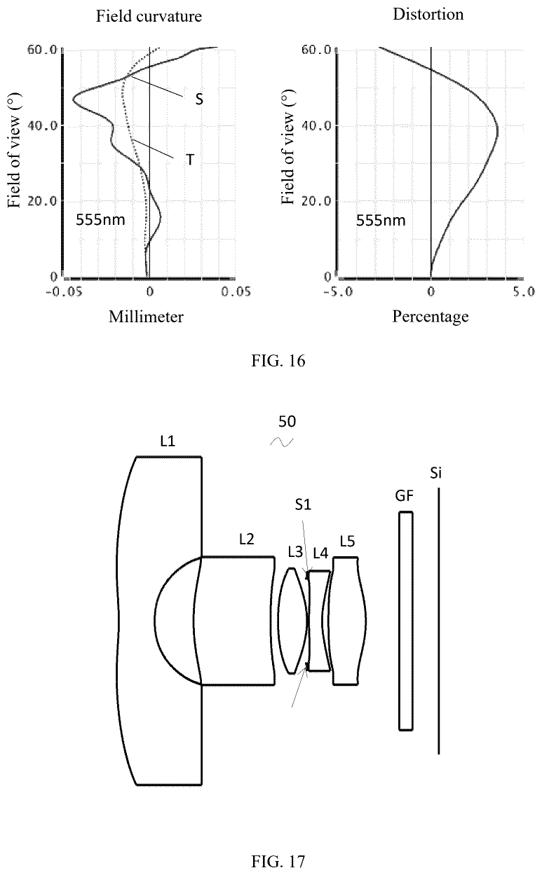

FIG. 14 and FIG. 15 illustrate a longitudinal aberration and a lateral color of the camera optical lens 40 according to the Fourth Embodiment after light with wavelengths of 650 nm, 610 nm, 555 nm, 510 nm, and 470 nm passing through the camera optical lens 40, respectively. FIG. 16 illustrates a field curvature and a distortion of the camera optical lens 40 after light with a wavelength of 555 nm passing through the camera optical lens 40 according to the Fourth Embodiment. A field curvature S in FIG. 16 is a field curvature in a sagittal direction, and Tis a field curvature in a tangential direction.

In the embodiment, an entrance pupil diameter (ENPD) of the camera optical lens 40 is 0.512 mm, an image height IH of 1.0H is 1.25 mm, a field of view FOV of 1.0H is 121.22°, an image height at MIC field position (IHm) is 1.39 mm, a field of view under MIC conditions (FOVm) is 118.28°. Thus, the camera optical lens 40 can meet the design requirements of a large aperture, a wide angle, and ultra-thin, and its on-axis and off-axis chromatic aberrations are fully corrected, thereby achieving excellent optical characteristics.

### Fifth Embodiment

The symbols in the Fifth Embodiment have the same meanings as those in the First Embodiment.

FIG. 17 shows the camera optical lens 50 according to the Fifth Embodiment of the present disclosure.

Table 9 and Table 10 show design data of the camera optical lens 50 according to the Fifth Embodiment of the present disclosure.

TABLE 9

| | R | d | | nd | | νd | |
|---|---|---|---|---|---|---|---|
| S1 | ∞ | d0 = | −2.768 | | | | |
| R1 | −2.270 | d1 = | 0.559 | nd1 | 1.5439 | v1 | 55.95 |
| R2 | 0.810 | d2 = | 0.607 | | | | |
| R3 | 1.807 | d3 = | 1.200 | nd2 | 1.6700 | v2 | 19.39 |
| R4 | 4.504 | d4 = | 0.117 | | | | |
| R5 | 1.837 | d5 = | 0.284 | nd3 | 1.5441 | v3 | 56.04 |
| R6 | −0.976 | d6 = | 0.031 | | | | |
| R7 | 1.426 | d7 = | 0.205 | nd4 | 1.6700 | v4 | 19.39 |
| R8 | 0.712 | d8 = | 0.100 | | | | |
| R9 | 4.126 | d9 = | 0.583 | nd5 | 1.5439 | v5 | 55.95 |
| R10 | −1.034 | d10 = | 0.519 | | | | |
| R11 | ∞ | d11 = | 0.210 | ndg | 1.5168 | vdg | 64.17 |
| R12 | ∞ | d12 = | 0.410 | | | | |

Table 10 shows aspherical surface data of each lens of the camera optical lens 50 in the Fifth Embodiment of the present disclosure.

TABLE 10

| | Conic | Aspheric surface coefficients | | | | | | |
|---|---|---|---|---|---|---|---|---|
| | k | A4 | A6 | A8 | A10 | A12 | A14 | A16 |
| R1 | −1.7885E− | 6.6360E−01 | −1.3407E+00 | 2.2734E+00 | −2.9409E+00 | 2.8409E+00 | — | 1.0993E+00 |
| R2 | −9.1605E− | 8.9787E−01 | 6.3647E+00 | −1.4813E+02 | 1.7170E+03 | −1.2893E+04 | 6.6750E+04 | — |
| R3 | — | 6.4557E−02 | −2.1239E+00 | 3.5653E+01 | −3.9720E+02 | 2.8987E+03 | — | 4.9780E+04 |
| R4 | — | 1.9043E−01 | −1.6449E+00 | 3.0328E+01 | −3.2532E+02 | 2.1566E+03 | — | 2.5227E+04 |
| R5 | 1.4032E+00 | 3.3819E−01 | 2.3583E+00 | −8.5740E+01 | 1.4982E+03 | −1.6708E+04 | 1.2460E+05 | — |
| R6 | −2.8780E− | — | 1.4813E+02 | −2.6758E+03 | 3.3036E+04 | −2.7862E+05 | 1.5285E+06 | — |
| R7 | — | — | 1.4388E+02 | −2.3383E+03 | 2.7828E+04 | −2.4000E+05 | 1.4853E+06 | — |
| R8 | −8.4690E− | — | 3.9958E+01 | −3.2541E+02 | 2.0285E+03 | −9.3022E+03 | 3.0419E+04 | — |
| R9 | 1.5971E+01 | −3.8796E−01 | 5.1643E+00 | −2.0269E+01 | 6.9166E+01 | −3.2280E+02 | 1.4373E+03 | — |
| R10 | — | 2.4578E−01 | −5.7893E+00 | 9.3609E+01 | −8.6702E+02 | 5.3654E+03 | — | 7.0259E+04 |

| | Conic | Aspheric surface coefficients | | | | | | |
|---|---|---|---|---|---|---|---|---|
| | k | A18 | A20 | A22 | A24 | A26 | A28 | A30 |
| R1 | −1.7885E− | −4.4117E−01 | 1.3134E−01 | −2.8557E−02 | 4.4014E−03 | −4.5516E−04 | 2.8308E−05 | −7.9992E− |
| R2 | −9.1605E− | 6.4765E+05 | — | 1.6820E+06 | −1.5967E+06 | 1.0028E+06 | −3.7434E+05 | 6.2955E+04 |
| R3 | — | −1.2131E+05 | 2.0756E+05 | — | 1.8789E+05 | — | 1.7248E+04 | — |
| R4 | — | −4.3056E+04 | 4.1375E+04 | — | −2.8929E+02 | — | 1.0128E+03 | 4.4787E+03 |
| R5 | 1.4032E+00 | 2.1973E+06 | — | 7.6957E+06 | −6.7162E+06 | 2.5889E+06 | −1.9017E+03 | 1.3229E+03 |
| R6 | −2.8780E− | −2.4399E+06 | 8.7356E+07 | — | 1.0619E+09 | — | 1.4229E+09 | — |
| R7 | — | 1.9583E+07 | — | 4.4618E+07 | −2.2971E+07 | 2.9958E+04 | −1.4648E+05 | 1.1813E+05 |
| R8 | −8.4690E− | 1.0342E+05 | — | 4.7517E+04 | −8.9103E+03 | — | −2.3778E+03 | 2.7948E+03 |
| R9 | 1.5971E+01 | 1.3869E+04 | — | 3.4281E+04 | −2.9694E+04 | 1.3204E+04 | −3.4850E+03 | 3.9087E+03 |
| R10 | — | −1.5454E+05 | 2.4567E+05 | — | 2.2181E+05 | — | 3.6464E+04 | — |

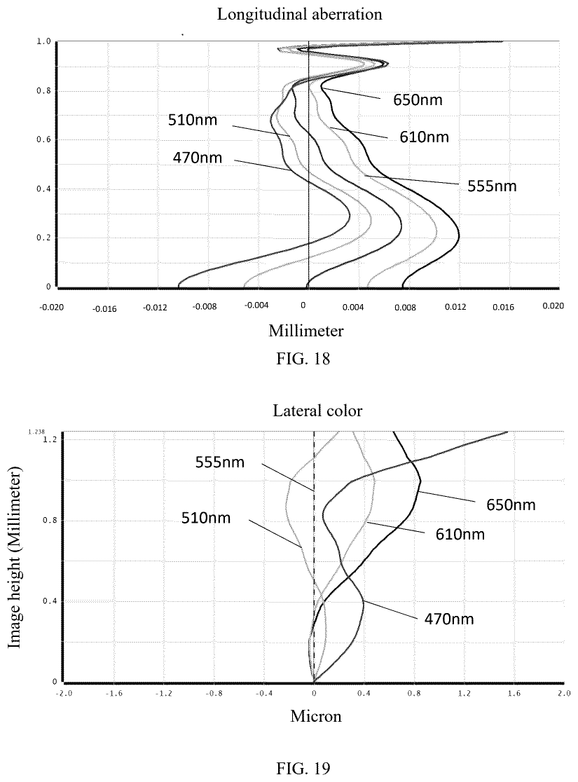

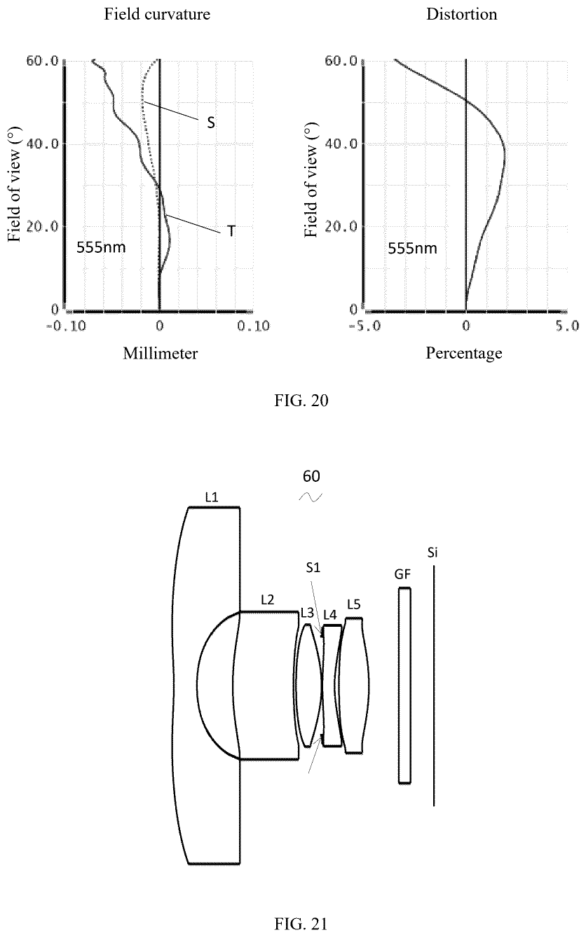

FIG. 18 and FIG. 19 illustrate a longitudinal aberration and a lateral color of the camera optical lens 50 according to the Fifth Embodiment after light with wavelengths of 650 nm, 610 nm, 555 nm, 510 nm, and 470 nm passing through the camera optical lens 50, respectively. FIG. 20 illustrates a field curvature and a distortion of the camera optical lens 50 after light with a wavelength of 555 nm passing through the camera optical lens 50 according to the Fifth Embodiment. A field curvature S in FIG. 20 is a field curvature in a sagittal direction, and T is a field curvature in a tangential direction.

In the embodiment, an entrance pupil diameter (ENPD) of the camera optical lens 50 is 0.517 mm, an image height IH of 1.0H is 1.24 mm, a field of view FOV of 1.0H is 120.78°, an image height at MIC field position (IHm) is 1.39 mm, a field of view under MIC conditions (FOVm) is 126.53°. Thus, the camera optical lens 50 can meet the design requirements of a large aperture, a wide angle, and ultra-thin, and its on-axis and off-axis chromatic aberrations are fully corrected, thereby achieving excellent optical characteristics.

Table 13 in the following lists various values in the First Embodiment, Second Embodiment, Third Embodiment, Fourth Embodiment, and Fifth Embodiment corresponding to the parameters in the above conditions.

### COMPARATIVE EXAMPLE

The symbols in the Comparative Example have the same meanings as those in the First Embodiment.

FIG. 21 shows the camera optical lens 60 according to the Comparative Example of the present disclosure.

Table 11 and Table 12 show design data of a camera optical lens 60 according to the Comparative Example of the present disclosure.

TABLE 11

| | R | d | | nd | | νd | |
|---|---|---|---|---|---|---|---|
| S1 | ∞ | d0 = | −2.666 | | | | |
| R1 | −2.341 | d1 = | 0.416 | nd1 | 1.5439 | v1 | 55.95 |
| R2 | 0.849 | d2 = | 0.645 | | | | |
| R3 | 1.606 | d3 = | 1.093 | nd2 | 1.6700 | v2 | 19.39 |
| R4 | 2.683 | d4 = | 0.046 | | | | |
| R5 | 2.119 | d5 = | 0.459 | nd3 | 1.5441 | v3 | 56.04 |
| R6 | −0.949 | d6 = | 0.015 | | | | |
| R7 | 1.220 | d7 = | 0.218 | nd4 | 1.6700 | v4 | 19.39 |
| R8 | 0.677 | d8 = | 0.080 | | | | |
| R9 | 2.708 | d9 = | 0.539 | nd5 | 1.5439 | v5 | 55.95 |
| R10 | −1.181 | d10 = | 0.539 | | | | |
| R11 | ∞ | d11 = | 0.210 | ndg | 1.5168 | vdg | 64.17 |
| R12 | ∞ | d12 = | 0.421 | | | | |

Table 12 shows aspherical surface data of each lens of the camera optical lens 60 in the Comparative Example of the present disclosure.

TABLE 12

| | Conic | Aspheric surface coefficients | | | | | | |
|---|---|---|---|---|---|---|---|---|
| | k | A4 | A6 | A8 | A10 | A12 | A14 | A16 |
| R1 | −3.0426E− | 6.5960E−01 | −1.3388E+00 | 2.2732E+00 | −2.9409E+00 | 2.8409E+00 | — | 1.0993E+00 |
| R2 | −7.6998E− | 8.4131E−01 | 6.4078E+00 | −1.4805E+02 | 1.7173E+03 | −1.2893E+04 | 6.6750E+04 | — |
| R3 | — | 5.4451E−02 | −2.1334E+00 | 3.5697E+01 | −3.9724E+02 | 2.8987E+03 | — | 4.9779E+04 |
| R4 | — | 2.0786E−01 | −1.7202E+00 | 3.1000E+01 | −3.2552E+02 | 2.1552E+03 | — | 2.5279E+04 |
| R5 | — | 1.6467E−01 | 3.3101E+00 | −8.7786E+01 | 1.4997E+03 | −1.6701E+04 | 1.2460E+05 | — |
| R6 | −1.4039E− | — | 1.4810E+02 | −2.6761E+03 | 3.3036E+04 | −2.7862E+05 | 1.5285E+06 | — |
| R7 | — | — | 1.4337E+02 | −2.3379E+03 | 2.7824E+04 | −2.4000E+05 | 1.4853E+06 | — |
| R8 | −9.1866E− | — | 4.0124E+01 | −3.2565E+02 | 2.0287E+03 | −9.3061E+03 | 3.0414E+04 | — |
| R9 | 8.1902E+00 | −6.8706E−01 | 5.2582E+00 | −1.9159E+01 | 7.2814E+01 | −3.2475E+02 | 1.4180E+03 | — |
| R10 | — | 1.7533E−01 | −5.8982E+00 | 9.3169E+01 | −8.6622E+02 | 5.3663E+03 | — | 7.0269E+04 |

| | Conic | Aspheric surface coefficients | | | | | | |
|---|---|---|---|---|---|---|---|---|
| | k | A18 | A20 | A22 | A24 | A26 | A28 | A30 |
| R1 | −3.0426E− | −4.4117E−01 | 1.3134E−01 | −2.8557E−02 | 4.4014E−03 | −4.5516E−04 | 2.8308E−05 | −7.9995E− |
| R2 | −7.6998E− | 6.4765E+05 | — | 1.6820E+06 | −1.5967E+06 | 1.0028E+06 | −3.7430E+05 | 6.2880E+04 |
| R3 | — | −1.2131E+05 | 2.0756E+05 | — | 1.8789E+05 | — | 1.7280E+04 | −7.4269E− |
| R4 | — | −4.3030E+04 | 4.1368E+04 | — | 0.0000E+00 | 0.0000E+00 | 0.0000E+00 | 0.0000E+00 |
| R5 | — | 2.1970E+06 | — | 7.6969E+06 | −6.7171E+06 | 2.5905E+06 | 0.0000E+00 | 0.0000E+00 |
| R6 | −1.4039E− | −2.4398E+06 | 8.7356E+07 | — | 1.0619E+09 | — | 1.4229E+09 | — |
| R7 | — | 1.9583E+07 | — | 4.4625E+07 | −2.2989E+07 | 0.0000E+00 | 0.0000E+00 | 0.0000E+00 |
| R8 | −9.1866E− | 1.0343E+05 | — | 4.7382E+04 | −8.3426E+03 | 0.0000E+00 | 0.0000E+00 | 0.0000E+00 |
| R9 | 8.1902E+00 | 1.3849E+04 | — | 3.4145E+04 | −2.8456E+04 | 1.3762E+04 | −3.4748E+03 | 0.0000E+00 |
| R10 | — | −1.5455E+05 | 2.4567E+05 | — | 2.2180E+05 | — | 3.6438E+04 | — |

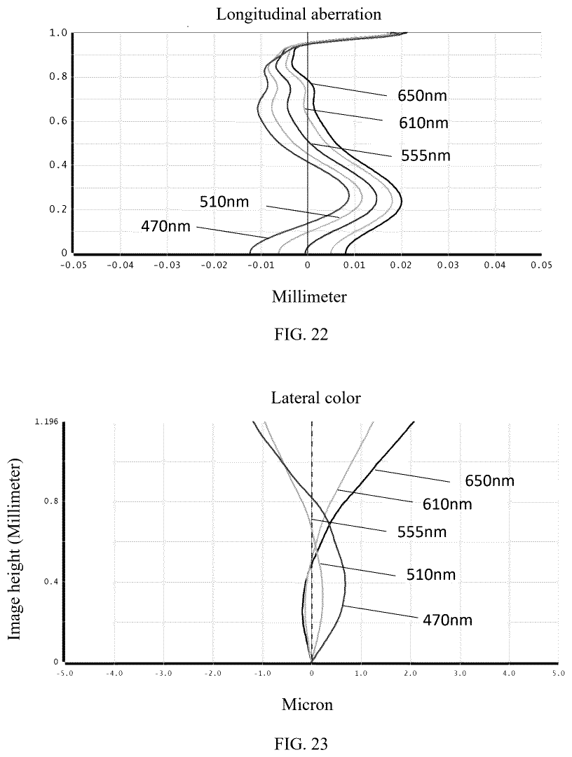

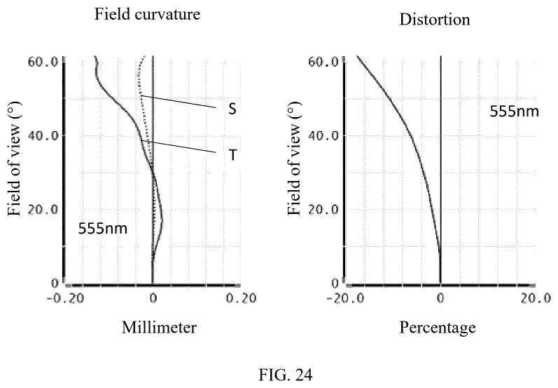

FIG. 22 and FIG. 23 illustrate a longitudinal aberration and a lateral color of the camera optical lens 60 according to the Comparative Example after light with wavelengths of 650 nm, 610 nm, 555 nm, 510 nm, and 470 nm passing through the camera optical lens 60, respectively. FIG. 24 illustrates a field curvature and a distortion of the camera optical lens 60 after light with a wavelength of 555 nm passing through the camera optical lens 60 according to the Comparative Example. A field curvature S in FIG. 24 is a field curvature in a sagittal direction, and T is a field curvature in a tangential direction.

Table 13 in the following lists various values in the Comparative Example corresponding to parameters in the above conditions. Obviously, the camera optical lens 60 according to the Comparative Example does not satisfy the above condition-0.65≤f3/f4≤−0.50.

In the Comparative Example, an entrance pupil diameter (ENPD) of the camera optical lens 60 is 0.562 mm, an image height IH of 1.0H is 1.20 mm, a field of view FOV of 1.0H is 123.17°, an image height at MIC field position (IHm) is 1.45 mm, a field of view under MIC conditions (FOVm) is 131.88°. Thus, various aberrations of the camera optical lens 60 are not fully corrected, and the camera optical lens 60 does not have excellent optical characteristics.

TABLE 13

| Parameters and | First | Second | Third | Fourth | Fifth | Comparative |
|---|---|---|---|---|---|---|
| Conditions | Embodiment | Embodiment | Embodiment | Embodiment | Embodiment | Example |
| f3/f4 | −0.59 | −0.65 | −0.62 | −0.62 | −0.51 | −0.47 |
| (d3 + d5)/TTL | 0.29 | 0.29 | 0.35 | 0.25 | 0.31 | 0.33 |
| (R1 + R2)/f1 | 1.47 | 1.90 | 1.11 | 1.40 | 1.42 | 1.37 |
| f | 0.773 | 0.749 | 0.750 | 0.721 | 0.729 | 0.792 |
| f1 | −1.121 | −1.116 | −1.050 | −1.035 | −1.028 | −1.091 |
| f2 | 3.426 | 4.108 | 3.486 | 3.836 | 3.784 | 4.197 |
| f3 | 1.312 | 1.279 | 1.207 | 1.228 | 1.211 | 1.267 |
| f4 | −2.228 | −1.968 | −1.932 | −1.978 | −2.378 | −2.684 |
| f5 | 1.489 | 1.468 | 1.606 | 1.556 | 1.578 | 1.584 |
| FNO | 1.41 | 1.41 | 1.41 | 1.40 | 1.41 | 1.41 |
| TTL | 4.955 | 5.126 | 4.873 | 5.023 | 4.825 | 4.681 |
| IH | 1.30 | 1.27 | 1.22 | 1.25 | 1.24 | 1.20 |
| FOV | 117.82° | 118.51° | 119.31° | 121.22° | 120.78° | 123.17° |
| ET1 | 0.964 | 1.034 | 1.039 | 1.119 | 1.017 | 0.762 |

Those skilled in the art shall understand that the embodiments described above are specific embodiments for implementing the present disclosure. In practice, various changes may be made to these embodiments in form and in detail without departing from the spirit and scope of the disclosure.

What is claimed is:

1. A camera optical lens, comprising, from an object side to an image side in sequence, a first lens with a negative refractive power, a second lens with a positive refractive power, a third lens with a positive refractive power, a fourth lens with a negative refractive power, and a fifth lens with a positive refractive power;
wherein the camera optical lens satisfies the following conditions:
$$- 0.65 \leq f 3 / f 4 \leq - 0.5 ;$$
$$0.25 \leq ( d 3 + d 5 ) / TTL \leq 0.35 ; and$$
$$1. \leq ( R 1 + R 2 ) / f 1 \leq 2. ;$$
wherein
f3 represents a focal length of the third lens;
f4 represents a focal length of the fourth lens;
d3 represents an on-axis thickness of the second lens;
d5 represents an on-axis thickness of the third lens;
TTL represents a total track length of the camera optical lens;
R1 represents a curvature radius of an object side surface of the first lens;
R2 represents a curvature radius of an image side surface of the first lens; and
f1 represents a focal length of the first lens.

2. The camera optical lens according to claim 1, further satisfies the following condition:
$$- 4. \leq R 9 / R 10 \leq - 1.5 ;$$
wherein
R9 represents a curvature radius of an object side surface of the fifth lens; and
R10 represents a curvature radius of an image side surface of the fifth lens.

3. The camera optical lens according to claim 1, further satisfies the following condition:
$$1.81 \leq ET 1 / d 1 \leq 2.1 ;$$
wherein
ET1 represents an edge thickness of the first lens; and
d1 represents an on-axis thickness of the first lens.

4. The camera optical lens according to claim 1, further satisfies the following condition:
$$2. \leq f 5 / d 9 \leq 3. ;$$
wherein
f5 represents a focal length of the fifth lens; and
d9 represents an on-axis thickness of the fifth lens.

5. The camera optical lens according to claim 1, wherein the object side surface of the first lens is concave in a paraxial region, and the image side surface of the first lens is concave in the paraxial region;
wherein the camera optical lens further satisfies the following conditions:
$$- 1.49 \leq f 1 / f \leq - 1.4 ;$$
$$0.4 \leq ( R 1 + R 2 ) / ( R 1 - R 2 ) \leq 0.57 ; and$$
$$0.101 \leq d 1 / TTL \leq 0.118 ;$$
wherein
f represents a focal length of the camera optical lens; and
d1 represents an on-axis thickness of the first lens.

6. The camera optical lens according to claim 1, wherein an object side surface of the second lens is convex in a paraxial region, and an image side surface of the second lens is concave in the paraxial region;
wherein the camera optical lens further satisfies the following conditions:
$$4.43 \leq f 2 / f \leq 5.49 ;$$
$$- 2.76 \leq ( R 3 + R 4 ) / ( R 3 - R 4 ) \leq - 1.39 ; and$$
$$0.177 \leq d 3 / TTL \leq 0.249 ;$$
wherein
f2 represents a focal length of the second lens;
f represents a focal length of the camera optical lens;
R3 represents a curvature radius of the object side surface of the second lens;
R4 represents a curvature radius of the image side surface of the second lens; and
d3 represents an on-axis thickness of the second lens.

7. The camera optical lens according to claim 1, wherein an object side surface of the third lens is convex in a paraxial region, and an image side surface of the third lens is convex in the paraxial region;
wherein the camera optical lens further satisfies the following conditions:
$$1.6 \leq f 3 / f \leq 1.71 ;$$
$$0.24 \leq ( R 5 + R 6 ) / ( R 5 - R 6 ) \leq 0.38 ; and$$
$$0.049 \leq d 5 / TTL \leq 0.109 ;$$
wherein
f represents a focal length of the camera optical lens;
R5 represents a curvature radius of the object side surface of the third lens;
R6 represents a curvature radius of an image side surface of the third lens; and
d5 represents an on-axis thickness of the third lens.

8. The camera optical lens according to claim 1, wherein the object side surface of the fourth lens is convex in a paraxial region, and the image side surface of the fourth lens is concave in the paraxial region;
wherein the camera optical lens further satisfies the following conditions:
$$- 3.27 \leq f 4 / f \leq - 2.57 ;$$
$$2.42 \leq ( R 7 + R 8 ) / ( R 7 - R 8 ) \leq 3. ; and$$
$$0.04 \leq d 7 / TTL \leq 0.045 ;$$
wherein
f represents a focal length of the camera optical lens;
R7 represents a curvature radius of the object side surface of the fourth lens;
R8 represents a curvature radius of an image side surface of the fourth lens; and
d7 represents an on-axis thickness of the fourth lens.

9. The camera optical lens according to claim 1, wherein an object side surface of the fifth lens is convex in a paraxial region, and an image side surface of the fifth lens is convex in the paraxial region;
wherein the camera optical lens further satisfies the following conditions:
$$1.92 \leq f 5 / f \leq 2.17 ; and$$
$$0.111 \leq d 9 / TTL \leq 0.155 ;$$
wherein
f5 represents a focal length of the fifth lens;
f represents a focal length of the camera optical lens; and
d9 represents an on-axis thickness of the fifth lens.

10. The camera optical lens according to claim 1, further satisfies the following condition:
$$TTL / IH \leq 4.02 ;$$
wherein
IH represents an image height of 1.0H of the camera optical lens.
